(19) United States
(12) Patent Application Publication
(10) Pub. No.: US 2010/0252496 A1
(43) Pub. Date: Oct. 7, 2010

(54) FILTER PAPER INSERT

(75) Inventors: Joachim Freiheit, Hille (DE); Michael Weber, Minden (DE)

Correspondence Address: VENABLE LLP, P.O. BOX 34385, WASHINGTON, DC, 20043-9998, US

(73) Assignee: Melitta Haushaltsprodukte GmbH & Co. KG, Minden (DE)

(21) Appl. No.: 12/752,689

(22) Filed: Apr. 1, 2010

(30) Foreign Application Priority Data
Apr. 6, 2009 (DE) 20 2009 002 039.8

(51) Int. Cl. B01D 29/085; B01D 39/18

(52) U.S. Cl. 210/489

(57) ABSTRACT

A filter paper insert for a filtration extract includes side walls surrounding an inside space that can be filled with the filtration extract. The side walls are comprised of at least two filter material layers.

### CROSS REFERENCE TO RELATED APPLICATION

This application claims the priority of German Patent Application No. 20 2009 002 039.8, filed on Apr. 6, 2009, the subject matter of which is incorporated herein by reference.

### BACKGROUND OF THE INVENTION

The invention relates to a filter paper insert, in particular used for coffee. Such an insert has side walls surrounding an inside space that can be filled.

Filter paper inserts are known which are substantially embodied in the shape of a truncated cone and comprise two side walls. The side walls are joined to each other via a folding edge, a side seam and a bottom seam. Filter paper inserts of this type have proven themselves, to be sure, since they are easy to fill with ground coffee or tea and can be disposed of following the use. The handling of these filter paper inserts is simple, wherein the filtering effect is predetermined by the selection of the filter material and the filtering time is predetermined by the flow resistance of the filter material, thus making impossible to adapt the filter capacity to different applications.

### SUMMARY OF THE INVENTION

It is therefore an object of the present invention to create a filter paper insert that is easy to handle and can be adapted to different filter applications.

The above and other objects are achieved according to the invention wherein there is provide, in one embodiment, a filter paper insert for a filtration extract, comprising: side walls surrounding an inside space that can be filled with the filtration extract, wherein the side walls are comprised of at least two filter material layers.

With the filter paper insert comprising side walls composed of at least two filter material layers, the user can optionally use both layers when producing a filtered beverage, or can remove one layer so that the flow resistance is reduced and the filtering time is consequently also reduced. On the one hand, this reduces the filtering time and, on the other hand, permits a better differentiation of the filtered beverages with respect to flavor. In addition, different filtration extracts can be filled into the filter paper insert, for example different types of coffee or tea.

According to one embodiment of the invention, the filter material layers are fixedly joined along one seam, thereby ensuring an easy handling because the at least two layers of filter material can be handled in the manner of a single layer and are positioned securely, relative to each other, owing to the connection along one seam. The seam can furthermore be embodied as a bottom seam and as a side seam. The filter material layers preferably fit loosely against each other outside of the seam, so as to allow an easy movement of the individual filter material layers. For example, the filter paper insert can be filled in such a way that three or more layers of filter material are arranged on one side while only one layer is arranged on the opposite side. The flow resistance on the side with only one filter material layer is thus clearly reduced.

According to a different embodiment of the invention, the filter material layers consist of different materials. The filter material layers in particular can consist of different types of filter paper, but also of nonwoven materials, foils, or other types of material. In addition, the filter material layers can be provided with perforations, markings or other elements. The filter material layers furthermore can be distinguished by having different colors, so that it is easy for the user to detect which filter material layers to use for the filling. The different layers can also have different thicknesses, for example the inner filter material layer can be thinner than the outer filter material layer. Furthermore the dimensions of the filter material layers can be varied, so that an inner filter paper layer is suitable for holding ground coffee for brewing a smaller amount of coffee while, for brewing a larger amount of coffee, the inner filter material layer is folded away and a larger inside space is thus made available for filling.

Two filter material layers are advantageously provided. Of course, it is also possible to produce the side walls with three or more filter material layers. In addition, the filter material layers can also be used to form coarse filters and micro-filters.

### BRIEF DESCRIPTION OF THE DRAWINGS

These and other features and advantages of the invention will be further understood from the following detailed description with reference to the accompanying drawings, to which reference is made for all details not further explained in the description.

FIG. 1 is a side view of a filter paper insert according to the invention.

FIG. 2 is a view showing a detail of the filter paper insert illustrated in FIG. 1.

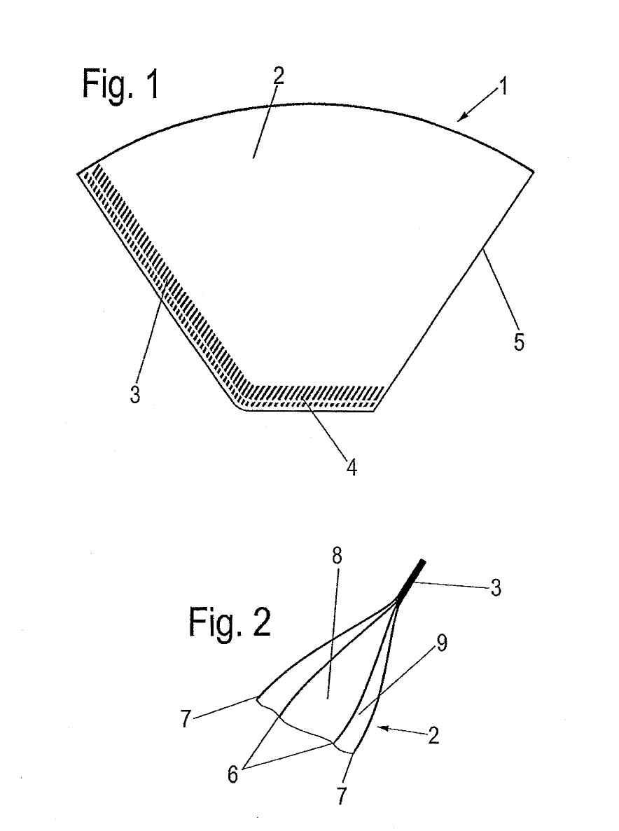

### DETAILED DESCRIPTION

Referring to the drawings, there is shown an embodiment of a filter paper insert 1 which comprises two side walls, substantially embodied so as to have a truncated cone shape. The side walls are fixedly connected along a side seam 3, in particular along an embossed seam. The side walls 2 are furthermore joined along a bottom seam 4 and a folding edge 5. The side walls can thus be pulled apart on the side opposite the bottom seam 4, such that an inside space can be filled with coffee, tea or other filtration extracts.

FIG. 2 shows the region of the filter paper insert that is adjacent to the side seam 3. The side walls 2 respectively comprise two filter material layers 6 and 7 which are joined along the side seam 3 and the bottom seam 4. The filter material layer 6 thus forms an inside filter which is surrounded by the layer 7.

The filter paper insert 1 can be filled in such a way that the inside space 8 is filled and the liquid is forced to flow through both filter material layers 6 and 7. These filter material layers 6 and 7 determine the flow resistance and the filtering time.

Alternatively, the user can fold over one layer of filter material 6 onto the adjacent filter material layer 6, so that an inside space 9 is created between the filter material layer 6 and the filter material layer 7 which can then be filled. For the embodiment shown herein, the two filter material layers 6 and one outer filter material layer 7 may be arranged on the one side of the filter while only an outer filter material layer 7 may be arranged on the other side. As a result, the flow resistance on the side having only one filter material layer 7 is reduced and thus also the filtering time, wherein this contributes to improving the flavor for specific applications.

With the embodiments shown herein, the filter material layers 6 and 7 are embodied with the same dimensions and are joined along the side seam 3 and the bottom seam 4. It is also possible to embody the filter material layer 6 with smaller dimensions than the filter material layer 7, so that different filling volumes result. In addition, the filter material layers 6 and 7 may be composed of different types of materials, for example coarse filtering and micro-filtering materials. The filter material layers 6 and 7 may additionally be provided with markings which explain the filling operation to the user.

It will be understood that the above description of the present invention is susceptible to various modifications, changes and adaptations, and the same are intended to be comprehended within the meaning and range of equivalents of the appended claims.

What is claimed is:

1. A filter paper insert for a filtration extract, comprising:
side walls surrounding an inside space that can be filled with the filtration extract, wherein the side walls are comprised of at least two filter material layers.

2. The filter paper insert according to claim 1, comprising one seam along which the layers are securely joined.

3. The filter paper insert according to claim 2, wherein the filter material layers fit loosely against each other outside of the seam.

4. The filter paper insert according to claim 1, wherein the filter material layers are comprised of different materials.

5. The filter paper insert according to claim 1, wherein the at least two filter material layers comprise solely two filter material layers.

6. The filter paper insert according to claim 5, wherein one of the filter material layers is inside the other filter material layer and the one filter material layer on the inside is thinner than the other filter material layer on the outside.

7. The filter paper insert according to claim 1, wherein the filter material layers comprise coarse filters and micro-filters.

8. The filter paper insert according to claim 1, wherein the filter material layers comprise different types of filter paper material.
